(19) United States
(12) Patent Application Publication
(10) Pub. No.: US 2011/0253398 A1
(43) Pub. Date: Oct. 20, 2011

(54) APPARATUS FOR MONITORING AND CONTROLLING SPONTANEOUS FIRING OF STORED COAL

(75) Inventor: Shinya MOURI, Tokyo (JP)

(73) Assignee: IHI Corporation, Koto-ku (JP)

(21) Appl. No.: 13/080,886

(22) Filed: Apr. 6, 2011

(30) Foreign Application Priority Data
Apr. 14, 2010 (JP) 2010-092700

(51) Int. Cl. A62C 37/10

(52) U.S. Cl. 169/60

(57) ABSTRACT

Thermocouples are suspended to extend vertically and centrally of a coal reservoir to sense temperatures of coal at vertically plural points. When at least one of temperatures of coal sensed exceeds a preset temperature, a purge command signal is output by a controller to an inert gas valve. When a temperature increase rate of at least one of the coal temperatures sensed exceeds a preset rate, a water spraying command signal is output by the controller to a water spraying valve.

### BACKGROUND OF THE INVENTION

1. Field of the Invention

The present invention relates to an apparatus for monitoring and controlling spontaneous firing of stored coal.

2. Description of the Related Art

Generally, coal used as fuel for a gasifier, a boiler or the like is stored in a coal reservoir such as a bunker or a silo. In particular, lignite coal and subbituminous coal tend to spontaneously fire due to high volatile thereof and require sufficient attention.

Conventionally, monitoring of spontaneous firing of coal stored in a coal reservoir is usually performed by temperature measurement in the reservoir.

State-of-the-art technology for an apparatus of monitoring spontaneous firing by temperature measurement of coal stored in a coal reservoir is disclosed, e.g., in JP 11-230835A.

### SUMMARY OF THE INVENTION

However, for a coal reservoir with a greater cross-sectional area, most of conventional monitoring apparatuses can conduct temperature measurement of coal only adjacent to a wall of a reservoir, which cannot be necessarily regarded sufficient to monitor spontaneous firing of coal. Even in an apparatus disclosed in JP 11-230835A, temperature measurement can be made only for coal adjacent to a bottom center of a coal reservoir, which cannot be necessarily regarded sufficient to monitor spontaneous firing of coal.

Tests actually conducted by the inventor to verify spontaneous firing phenomenon of coal revealed that firing is triggered by temperature increase of stored coal centrally of a coal reservoir. It is, therefore, highly desirable to monitor a temperature of stored coal centrally of a coal reservoir.

The invention was made in view of the above and has its object to provide an apparatus for monitoring and controlling spontaneous firing of stored coal capable of reliably sensing temperatures of stored coal centrally of a coal reservoir and preventing spontaneous firing of coal from occurring.

The invention is directed to an apparatus for monitoring and controlling spontaneous firing of stored coal comprising

temperature detection means suspended to vertically extend centrally of a coal reservoir for sensing temperatures of coal at vertically plural points,

inert gas purge means for supplying inert gas into said coal reservoir and

a controller for outputting a purge command signal to said inert gas purge means when at least one of the coal temperatures sensed at the vertically plural points by said temperature detection means exceeds a preset temperature.

According to the above apparatus, the following effects and advantages will be obtained.

With the apparatus constructed as mentioned in the above, the temperature detection means suspended to vertically extend centrally of the coal reservoir senses the coal temperatures at the vertically plural points, so that temperature change of the stored coal centrally of the coal reservoir can be grasped. When at least one of the coal temperatures sensed by the temperature detection means at the vertically plural points exceeds the preset temperature, a purge command signal is output by the controller to the inert gas purge means, so that inert gas is supplied from said inert gas purge means into the coal reservoir to prevent temperature increase of coal involved in oxidation thereof.

The apparatus for monitoring and controlling spontaneous firing of stored coal may further comprise means for spraying water in said coal reservoir,

a water spraying command signal being output by said controller to said water spraying means when a temperature increase rate of at least one of the coal temperatures sensed by said temperature detection means exceeds a preset rate. Thus, the fact that the temperature increase rate of at least one of the coal temperatures sensed by the temperature detection means at the vertically plural points exceeds the preset rate is regarded as occurrence of spontaneous firing and water is sprayed by the water spraying means in the coal reservoir, enabling reliable extinction.

In the apparatus for monitoring and controlling spontaneous firing of stored coal, said temperature detection means may comprise a plurality of thermocouples extending through a flexible metal tube, an outer periphery of said flexible metal tube being covered with wire ropes. This makes it possible to exert high durability and high impact resistance under a severe service condition in the coal reservoir to and from which coal is supplied and discharged.

In the apparatus for monitoring and controlling spontaneous firing of stored coal, temperature change of the stored coal centrally of the coal reservoir can be reliably sensed to prevent spontaneous firing of coal from occurring.

### BRIEF DESCRIPTION OF THE DRAWINGS

FIG. 1 is a schematic overview showing an embodiment of an apparatus for monitoring and controlling spontaneous firing of coal according to the invention;

FIG. 2 is a sectional view showing thermocouples used as temperature detection means in the apparatus for monitoring and controlling spontaneous firing of coal according to the invention;

FIG. 3 is a sectional view showing a testing device verifying spontaneous firing phenomenon of coal; and

FIG. 4 is a diagram showing temperature change of coal obtained in a test using testing devices of FIG. 3.

### DESCRIPTION OF THE PREFERRED EMBODIMENT

An embodiment of the invention will be described in conjunction with the attached drawings.

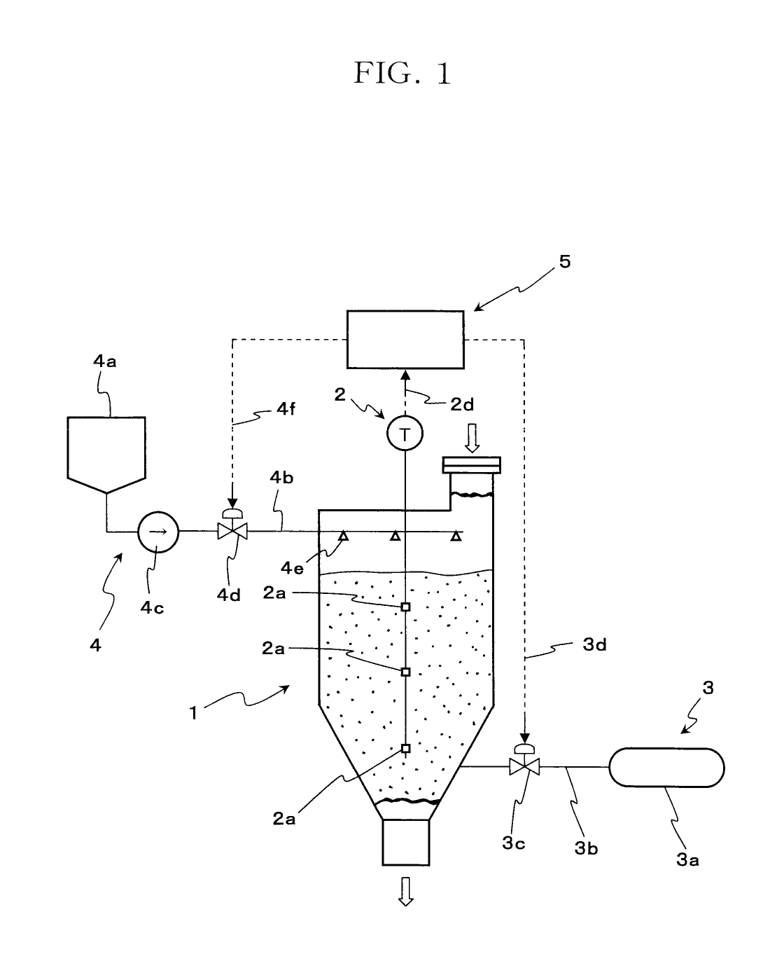

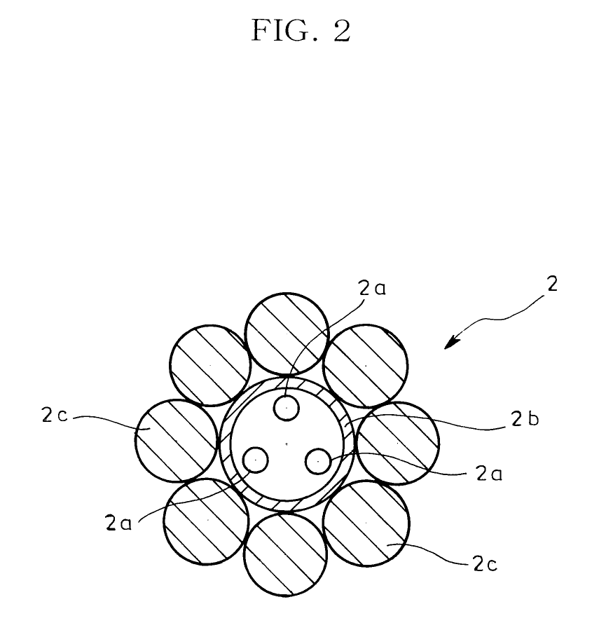

FIGS. 1 and 2 show the embodiment of an apparatus for monitoring and controlling spontaneous firing of stored coal according to the invention in which reference numeral 1 denotes a coal reservoir such as a bunker or a silo for storage of coal used as fuel in a gasifier, a boiler or the like. Suspended centrally of the coal reservoir 1 to vertically extend is temperature detection means 2 which senses coal temperatures 2d at vertically plural points (three in the figure).

In the embodiment, the temperature detection means 2 comprises, as shown in FIG. 2, three thermocouples 2a coated with FEP (Fluorinated Ethylene Propylene) and extending through a flexible metal tube 2b made of stainless steel, an outer periphery of the flexible metal tube 2b being covered with wire ropes 2c, so that high durability and high impact resistance can be exerted under a severe service condition in the coal reservoir 1 to and from which coal is supplied and discharged. The thermocouples 2a illustrated are three in number to sense the coal temperatures 2d at vertically three points centrally of the coal reservoir 1; needless to say, the thermocouples may be two or more than three to sense the coal temperatures 2d at vertically plural points centrally of the coal reservoir 1.

The coal reservoir 1 is provided with inert gas purge means 3 to supply nitrogen or other inert gas 1 into the coal reservoir 1 as well as means 4 to spray water in the coal reservoir 1.

The inert gas purge means 3 comprises an inert gas cylinder 3a charged under pressure with nitrogen or other inert gas, an inert gas supply piping 3b extending from the cylinder 3a and connected to the coal reservoir 1 and an inert gas valve 3c incorporated in the inert gas supply piping 3b.

The water spraying means 4 comprises a water reservoir 4a for storage of water for water spraying, a water supply piping 4b extending from the water reservoir 4a to an upper position in the coal reservoir 1, a water squeeze pump 4c incorporated in the water supply piping 4b, a water spraying valve 4d incorporated in the water supply piping 4b and on a discharge side of the water squeeze pump 4c and water spraying nozzles 4e attached to the water supply piping 4b at the upper position in the coal reservoir 1.

Further arranged is a controller 5 to which input are the coal temperatures 2d at the vertically plural points sensed by the thermocouples 2a of the temperature detection means 2. When at least one of the coal temperatures 2d sensed at the vertically plural points by the thermocouples 2a of the temperature detection means 2 exceeds a preset temperature (e.g., 80° C.), a purge command signal 3d is output by the controller 5 to the inert gas valve 3c of the inert gas purge means 3. When a temperature increase rate of at least one of the coal temperatures 2d sensed by the thermocouples 2a of the temperature detection means 2 exceeds a preset rate (e.g., 1° C./min), a water spraying command signal 4f is output by the controller 5 to the water spraying valve 4d of the water spraying means 4.

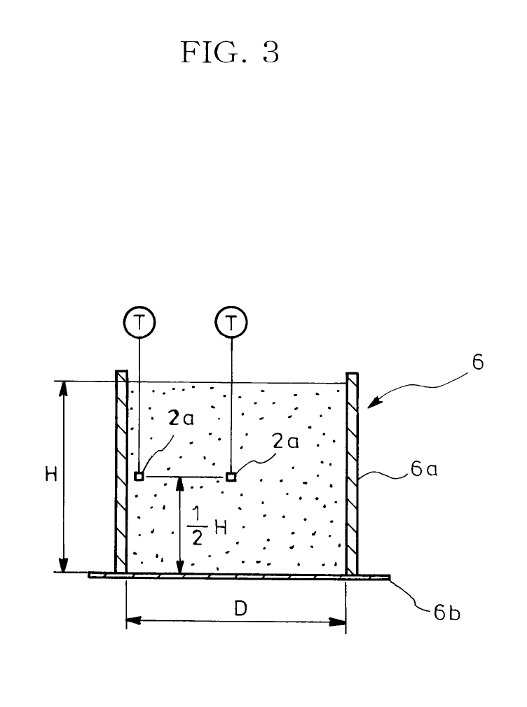

FIG. 3 shows a testing device used in a test actually conducted by the inventor to verify spontaneous firing phenomenon of coal; with respect to a layer of pulverized coal charged in test cells 6 as receptacles for firing temperature test, temperature change with time is measured to monitor behaviors of temperature increase of coal leading to spontaneous firing of coal.

In the test, pulverized coal classified into particle size of less than 200 meshes (74 μm) and dried is charged into three kinds of test cells 6 different in height and in inner diameter so as to have different layer heights H and diameters D of pulverized coal as shown in Table 1, the test cells 6 being arranged in a thermobath (not shown) kept to a predetermined atmosphere temperature (e.g., 141° C.). With the thermocouples 2a being set centrally of the test cell 6 at height half as high as the layer height H and being set about 10 mm apart from an inner wall surface of the test cell 6 (about 5 mm apart from the wall surface in a case of layer height H and diameter D being respectively 30 mm) at height half as high as the layer height H, respectively, temperature change with time of the pulverized coal layer and presence or absence of spontaneous firing are measured. In order to allow oxygen supply not only on an upper surface of but also on a side surface of accumulated pulverized coal just like real apparatuses, a side wall 6a of each of the test cells 6 was made of alumina paper with thickness of 3 mm. A bottom plate 6b of each of the test cells 6 was made of stainless steel with thickness of 1 mm.

TABLE 1

| layer height | diameter | coal sample |
|---|---|---|
| H mm | D mm | amount g |
| 30 | 30 | about 10 |
| 60 | 60 | about 100 |
| 100 | 100 | about 450 |

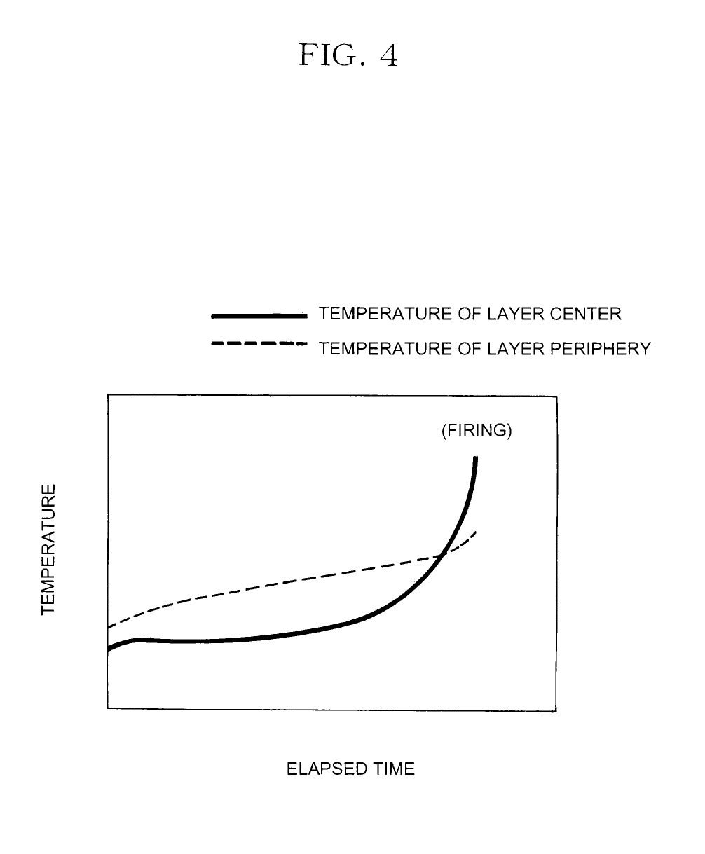

It was ascertained in any of the three kinds of test cells 6 that temperature change with time of layer center and layer periphery have tendencies as shown in FIG. 4. Specifically, it was ascertained that, though temperature of layer periphery is generally higher than temperature of layer center because of temperature transferred to the pulverized coal charged in the test cell 6 through the opened upper surface and the periphery of the test cell, the temperature of layer periphery is moderate in change and abrupt change thereof leading to firing is difficult to sense and that eventually the layer center has abrupt temperature change (about 1° C./min or so) sooner than the layer periphery, leading to firing at the layer center. From such reason, it is highly desirable to monitor the coal temperatures 2d centrally of the coal reservoir 1.

Next, an operation of the above embodiment will be described.

With the apparatus constructed as mentioned in the above, the coal temperatures 2d at the vertically plural points are sensed by the thermocouples 2a of the temperature detection means 2 suspended centrally of the coal reservoir 1 to extend vertically, so that temperature change of the stored coal centrally of the coal reservoir 1 can be determined. When at least one of the coal temperatures 2d at the vertically plural points sensed by the thermocouples 2a of the temperature detection means 2 exceeds a preset temperature (e.g., 80° C.), the controller 5 outputs a purge command signal 3d to the inert gas valve 3c of the inert gas purge means 3, so that inert gas valve 3c is opened to supply inert gas from the inert gas cylinder 3a into the coal reservoir 1 through the inert gas supply piping 3b to thereby prevent temperature increase upon oxidation of the coal.

When a temperature increase rate of at least one of the coal temperatures 2d at the vertically plural points sensed by the thermocouples 2a of the temperature detection means 2 exceeds a preset rate (e.g., 1° C./min), it is regarded as occurrence of spontaneous firing and water spraying command signal 4f is output by the controller 5 to the water spraying valve 4d of the water spraying means 4, so that the water spraying valve 4d is opened and water is supplied from the water reservoir 4a via the water supply piping 4b into the coal reservoir 1 by driving the water squeeze pump 4c and is sprayed by the water spraying nozzles 4e. Thus, extinction can be conducted reliably.

Moreover, the fact that the temperature detection means 2 comprises, as shown in FIG. 2, the three thermocouples 2a coated with FEP extending through the flexible metal tube 2b made of stainless steel or the like, the outer periphery of the flexible metal tube 2b being covered with the wire ropes 2c, makes it possible to exert high durability and impact resistance under a severe service condition in the coal reservoir 1 to and from which coal is supplied and discharged.

Thus, temperature change of stored coal centrally of the coal reservoir 1 can be reliably sensed and spontaneous firing of coal can be prevented from occurring.

It is to be understood that an apparatus for monitoring and controlling spontaneous firing of stored coal according to the invention is not limited to the above embodiment and that various changes and modifications may be made within a gist of the invention.

What is claimed is:

1. An apparatus for monitoring and controlling spontaneous firing of stored coal comprising
temperature detection means suspended to vertically extend centrally of a coal reservoir for sensing temperatures of coal at vertically plural points,
inert gas purge means for supplying inert gas into said coal reservoir and
a controller for outputting a purge command signal to said inert gas purge means when at least one of the coal temperatures sensed at the vertically plural points by said temperature detection means exceeds a preset temperature.

2. The apparatus for monitoring and controlling spontaneous firing of stored coal as claimed in claim 1, further comprising means for spraying water in said coal reservoir,
a water spraying command signal being output by said controller to said water spraying means when a temperature increase rate of at least one of the coal temperatures sensed by said temperature detection means exceeds a preset rate.

3. The apparatus for monitoring and controlling spontaneous firing of stored coal as claimed in claim 1, wherein said temperature detection means comprises a plurality of thermocouples extending through a flexible metal tube, an outer periphery of said flexible metal tube being covered with wire ropes.

4. The apparatus for monitoring and controlling spontaneous firing of stored coal as claimed in claim 2, wherein said temperature detection means comprises a plurality of thermocouples extending through a flexible metal tube, an outer periphery of said flexible metal tube being covered with wire ropes.
